(19) United States
(12) Patent Application Publication
(10) Pub. No.: US 2016/0000177 A1
(43) Pub. Date: Jan. 7, 2016

(54) SOCK WITH INCLUDED MASSAGE ELEMENTS

(71) Applicant: Hayim Jacob Barkol, Brooklyn, NY (US)

(72) Inventor: Hayim Jacob Barkol, Brooklyn, NY (US)

(21) Appl. No.: 14/740,867

(22) Filed: Jun. 16, 2015

Related U.S. Application Data
(60) Provisional application No. 62/012,708, filed on Jun. 16, 2014.

(51) Int. Cl. A43B 7/14; A61H 39/04; A41B 11/00

(52) U.S. Cl. CPC A43B 7/146; A41B 11/00; A61H 39/04; A61H 2205/12

(57) ABSTRACT

A massage sock is provided having a stretchable fabric and a plurality of massage elements attached to the bottom of the foot of said sock, where the massage elements are located at discrete locations corresponding to reflexology body parts.

### RELATED APPLICATIONS

This application claims the benefit of priority from U.S. Provisional Application No. 62/012,708, filed on Jun. 16, 2014, the entirety of which is incorporated by reference.

### BACKGROUND

1. Field of the Invention

This application relates to socks. More particularly, this application relates to socks with massage elements included/coupled directly to the sock fabric.

2. Description of Related Art

In the area of foot massage there are numerous devices that can be used. However, typical foot massage devices require the shoe to be removed and thus have only limited home use applications.

Another type of foot massage device is for a sole insert for the inside of a shoe. This type of insert can be worn all day but has several drawbacks including that it needs to be moved from shoe to shoe, it needs to be frequently washed, and in some cases if it does not fit in different shoes then a user would need multiple sets of inserts.

### OBJECTS AND SUMMARY

The present arrangement provides for a sock with massage elements directly included in the fabric of the sock. Such massage elements may be located in discrete locations for the purposes of reflexology massage.

To this end the present arrangement provides a massage sock having a stretchable fabric and a plurality of massage elements attached to the bottom of the foot of said sock, where the massage elements are located at discrete locations corresponding to reflexology body parts.

### BRIEF DESCRIPTION

The present invention can be understood through the following description and accompanying drawings, wherein:

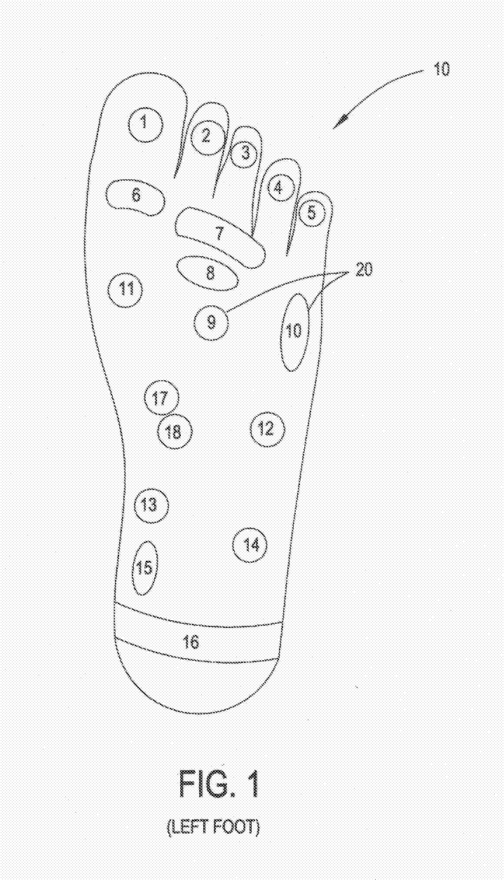

FIG. 1 is an exemplary left sock, in accordance with one embodiment; and

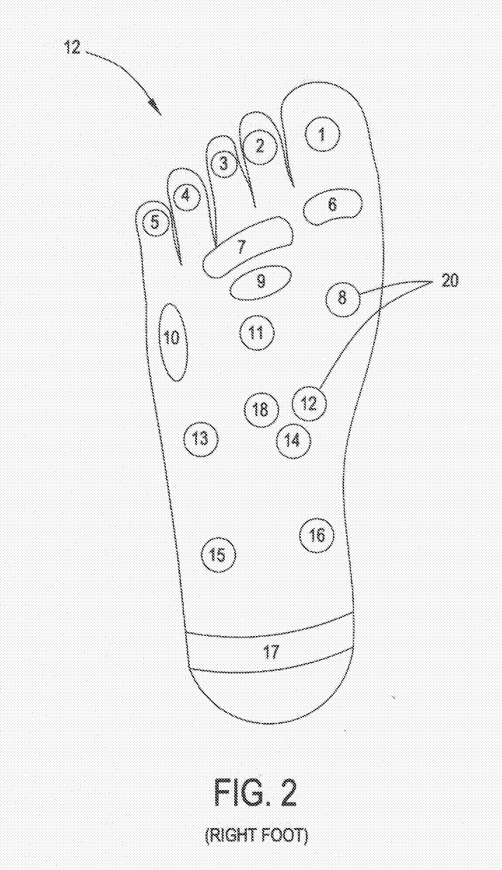

FIG. 2 is an exemplary right sock, in accordance with one embodiment.

### DETAILED DESCRIPTION

As shown in FIGS. 1 and 2, the present arrangement provides left and right socks 10 and 12 respectively with massage elements 20 directly included in the fabric,

According to a preferred embodiment, each of socks 10 and 12 are constructed of a machine washable and stretchable fabric such as elastic, however, any suitable fabric may be used.

According to another preferred embodiment, each of massage elements 20 are constructed as sealed silicone elements that are either glued or stitched into the base of socks 10 and 12, provided that such attachment is able to withstand the ordinary wear and tear of a person walking thereon and washing without elements 20 moving or falling off.

According to another preferred embodiment, massage elements 20 are constructed to a desired hardness to balance between enough hardness to effectively massage the targeted areas on the bottom of the wearer's foot but soft enough so as not to Injure the sole of the foot or otherwise simply be uncomfortable, Materials such as silicone that are used for massage elements 20 are measured for hardness using the Shore scale (i.e. using a Shore duromoter). Shore hardness can be measured in different scales (e.g. “OO,” “A,” “D”etc. . . . ) depending on the general hardness of the material. Silicone/Silicone products are usually measured on the Shore A scale. In the present arrangement, massage elements are constructed of silicone or a silicone mixture having a Shore hardness ranging from 16A (softest) to 24A (hardest) but with typical elements being about 20A. It is noted that the preferred embodiment of silicone for massage elements 20 should not be considered limiting, but any such soft rubbery material of substantially the same hardness may be used.

In another preferred embodiment the location of massage elements on the base of socks 10 and 12 correspond to massage locations on the wearer's foot designated as reflexology points. Reflexology generally refers to foot massage locations on the bottom of feet each of which corresponds to a particular body part/gland/organ etc. . . . such that massage or stimulation of that location provides corresponding beneficial effects for that body part. As shown in FIGS. 1 (left sock 10) and 2 (right sock 12), there are a number of discrete locations for each of massage elements 20.

The following list is an exemplary list of locations for massage elements 20 corresponding to left foot sock 10 with corresponding dimensions and hardness measurements along with the affected body part according to Reflexology.

FIG. 1 (left foot sock 10)—

Point 1, Sinus & pituitary gland, 10 mm Diameter×6 mm High.

Density of 20.0 HA. (Round shape).

Point 2. Sinus. 10 mm Diameter×6 mm High. Density of 20.0 HA. (Round Shape).

Point 3. Sinus. 10 mm Diameter×6 mm High. Density of 20.0 HA. (Round Shape).

Point 4, Sinus. 10 mm Diameter×6 mm High. Density of 20.0 HA. (Round Shape).

Point 5. Sinus, 10 mm Diameter×6 mm High. Density of 20.0 HA, (Round Shape).

Point 6. Neck/Thyroid/Throat. 20 mm Long×10 mm Wide×6 mm High. Density of 20.0 HA.(Oval shape).

Point 7. Eyes & Ears. 30 mm Long×10 mm Wide×6 mm High. Density of 20.0 HA, (Oval shape).

Point 8. Lungs & Heart. 24 mm Long×15 mm Wide×6 mm High. Density of 20.0 HA. (Oval shape).

Point 9. Solar plexus. 15 mm Diameter×6 mm High. Density of 20.0 HA. (Round shape).

Point 10. Shoulder. 24 mm Long×15 mm Wide×6 mm High. Density of 20.0 HA. (Oval shape).

Point 11 Thymus. 15 mm Diameter×6 mm High. Density of 20.0 HA. (Round shape).

Point 12. Stomach, Spleen. 15 mm Diameter×6 mm High. Density of 20.0 HA. (Round shape).

Point 13. Small intestine. 15 mm Diameter×6 mm High. Density of 20.0 HA, (Round shape).

Point 14. Descending colon. 15 mm Diameter×6 mm High. Density of 20.0 HA. (Round shape).

Point 15. Bladder & Rectum. 20 mm Long×10 mm Wide×6 mm High. Density of 20.0 HA. (Oval shape).

Point 16. Sciatic, 45 mm Long×10 mm Wide×6 mm High. Density of 20.0 HA. (Oval shape).

Point 17. Adrenal gland. 15 mm Diameter×6 mm High. Density of 20.0 HA. (Round shape).

Point 18. Kidney. 15 mm Diameter×6 mm High. Density of 20.0 HA. (Round shape).

FIG. 2 (right foot sock 12)—

Point 1. Sinus & pituitary gland, 10 mm Diameter×6 mm High. Density of 20.0 HA. (Round shape).

Point 2. Sinus. 10 mm Diameter×6 mm High. Density of 20.0 HA. (Round shape).

Point 3. Sinus. 10 mm Diameter×6 mm High. Density of 20.0 HA. (Round shape).

Point 4, Sinus. 10 mm Diameter×6 mm High. Density of 20.0 HA. (Round shape).

Point 5. Sinus. 10 mm Diameter×6 mm High. Density of 20.0 HA, (Round shape).

Point 6. Neck/Thyroid/Throat. 20 mm Long×10 mm Wide×6 mm High. Density of 20.0 HA.(Oval shape).

Point 7. Eyes & Ears. 30 mm Long×10 mm Wide×6 mm High. Density of 20.0 HA. (Oval shape).

Point 8. Thymus. 15 mm Diameter×6 mm High. Density of 20.0 HA. (Round shape).

Point 9. Lungs & Heart. 24 mm Long×15 mm Wide×6 mm High. Density of 20.0 HA. (Oval shape).

Point 10. Shoulder. 24 mm Long×15 mm Wide×6 mm High. Density of 20.0 HA. (Oval shape).

Point 11. Solar plexus. 15 mm Diameter×6 mm High. Density of 20.0 HA. (Round shape).

Point 12. Liver. 15 mm Diameter×6 mm High. Density of 20.0 HA. (Round shape).

Point 13. Transverse colon. 15 mm Diameter×6 mm High. Density of 20.0 HA. (Round shape).

Point 14. Kidney. 15 mm Diameter×6 mm High. Density of 20.0 HA. (Round shape).

Point 15. Ascending colon. 15 mm Diameter×6 mm High, Density of 20.0 HA. (Round shape).

Point 16. Intestine. 15 mm Diameter×6 mm High. Density of 20.0 HA. (Round shape).

Point 17. Sciatic. 45 mm Long×10 mm Wide×6 mm High. Density of 20.0 HA. (Oval shape).

Point 18. Adrenal gland. 15 mm Diameter×6 mm High. Density of 20.0 HA. (Round shape).

It is understood that the above listed locations for massage elements 20 as well the dimensions and hardness should be considered exemplary and non-limiting. Other socks with massage elements 20 using different locations, shapes, hardnesses etc. . . . may be included within the scope of the present invention.

Such an arrangement as described herein, by including massage elements 20 within the sock fabric, massage elements 20 can be used regardless of the shoes worn. Additionally, it is very easy to put on massage elements 20 in the correct locations as they are sewn into socks 10/12 so there is no issue with a large in-shoe insert moving within the shoe. Massage elements 20 and socks 10/12 are easily removable at night, as with any sock making it very easy to remember to continuously wash them.

Although the present invention has been described in accordance with the embodiments shown, one of ordinary skill in the art will readily recognize that there could be variations made to the embodiments without departing from the scope of the present invention. Accordingly, it is intended that all ratter contained in the above application and shown in the accompanying drawings shall be interpreted as illustrative and not a means of demonstrating the limits of technology.

1. A massage sock comprising:
a stretchable fabric; and
a plurality of massage elements attached to the bottom of the foot of said sock;
wherein said massage elements are located at discrete locations corresponding to reflexology body parts.

2. The sock as claimed in claim 1, wherein said fabric is elastic.

3. The sock as claimed in claim 1, wherein said massage elements are made from silicone or a silicone containing mixture.

4. The sock as claimed in claim 1, wherein said massage elements are either one of glued to said sock or stitched into the fabric of said sock.

5. The sock as claimed in claim 1, wherein said massage elements are each discretely sized and shaped to correspond to said reflexology body parts.
